(19) United States
(12) Patent Application Publication
(10) Pub. No.: US 2019/0156543 A1
(43) Pub. Date: May 23, 2019

(54) SYSTEM AND METHOD FOR EMBEDDED REAL-TIME AUTOMATIC UPDATING OF AN INTERACTIVE SAAS BASED SLIDE PRESENTATION APPLICATION

(71) Applicant: Samer Zawaideh, Burr Ridge, IL (US)

(72) Inventor: Samer Zawaideh, Burr Ridge, IL (US)

(21) Appl. No.: 16/195,056

(22) Filed: Nov. 19, 2018

Related U.S. Application Data
(60) Provisional application No. 62/587,702, filed on Nov. 17, 2017.

(51) Int. Cl. G06T 11/60; G06F 9/451; G06F 17/21

(52) U.S. Cl. CPC G06T 11/60; G06T 2200/24; G06F 17/212; G06F 9/453

(57) ABSTRACT

A system and method for embedded real-time automatic updating of an interactive SAAS based slide presentation application. The system creates dynamic representations of data that interacts with and monitors the data in its source location. Whenever the data changes the system recalculates and adjusts the visual representation of the data dynamically, which allows the presentations slides to update automatically without user intervention. The invention also uses visual representations with embedded configurations, mapping, and logic that allows these representation to accept user interaction during presentation time and adjust their appearance accordingly.

### CROSS-REFERENCE TO RELATED APPLICATION

This application claims the benefit of priority of U.S. provisional application No. 62/587,702, filed Nov. 17, 2017, the contents of which are herein incorporated by reference.

### BACKGROUND OF THE INVENTION

The present invention relates to all presentation graphics and data content in presentation slides, and more particularly to automatically updating of presentation graphics and data content to reflect changes in the content of a graphics presentation.

Current Slide Presentation solutions depend on a user's manual input and primarily cut and paste or manual copying to create and update a slide presentation. Not only is the above process slow, it is also inaccurate since the representation of information and data could be stale by the time it is presented.

Existing presentation graphics solutions like Power Point or Prezi, Google Slides, Sales Preso, Keynote, Haiku Deck, etc. cannot address the above real time data problem because the fundamental building blocks of the visual slides don't contain the intelligence, logic, data source mapping and self-adjusting style logic that allows them to link to multiple data sources to adjust, recalculate, and re-visualize in real-time. Current existing presentation software also have no ad hoc interactivity and data adjustment between user and data during presentation time.

Moreover, current solutions also limit the amount of data that can be shown in a slide due to the static nature of the graphical or textual representations in a slide and do not provide the ability to explore, interact and mine the data that is represented in the slides during a presentation.

Current solutions are standalone applications that require and assume their own separate original content and data source system for the creation and display system, thus resulting in cut and paste or simple data exchange scenarios. The above situation results in inefficiencies, wasted time and inaccuracies.

As can be seen, there is a need for a system and method of providing automatic updates to the contents of a slide presentation.

### SUMMARY OF THE INVENTION

In one aspect of the present invention, a system for dynamically updating a graphical representation of data utilizing a graphics slide presentation system which can be embedded in web base systems is disclosed. The system includes a data source associated with one or more abstract presentation objects embedded in a web slide to create a graphic web presentation that is embedded as a native graphic slide presentation in a source application. A read object associations and mapping objects subsystem is configured to map and link the one or more abstract presentation objects to a specific visual representation of the data in the native slide in which it is implemented. A slide creation and positioning component is configured to determine a position and a layout of a slide representation in a slide presentation displayed as a single page web application, wherein each slide representation occupies a slide region within the single page web application, this allows for non-linear or non-sequential traversal from one slide to the next of based on the users choice.

A parse presentation objects component is configured to parse data from the data source corresponding to the one or more abstract presentation objects for the graphic slide presentation. The parsing component procures the data from the appropriate data source through the use of native methods that interface with available APIs (Application Programming Interfaces) of the data sources. A device media display properties component is automatically configured internally by the system to read one or more display properties and one or more device media properties of a computing device from which the single page web application is accessed. The device media display properties component determines a scale and an aspect ratio in which to display the graphic slide presentation on the computing device. The one or more display and the one or more device media properties are read via an HTML5 media queries.

In some embodiments, an add real time widgets component is configured to determine a position of a display widget in the slide region as an offset of the slide coordinate system, to allow each slide representation to be repositioned and resized independently. An object association component may be configured to associate the one or more abstract presentation objects as a link mapped to the graphic slide presentation.

In other embodiments, a real-time widget components and configuration subsystem utilizes one or more of HTML5, Angular, JavaScript and JQuery implementations of the display widget. The display widgets are the visual representation of the abstract presentation objects. The real-time widget components and configuration subsystem may include a plurality of display widgets. Each widget may have a wizard configuration UI which collects a widget configuration as a stored JSON configuration string and function.

In yet other embodiments, a map source data to a widget visual representation component may be configured to parse the links and mapping from the object association component and calls a native extract routines from the data source to provide input data. A map source data to widget visual representation component may be provided to map the input data to the UI widgets presentations from the real-time widget components and configuration subsystem.

In other aspects of the invention, a method for dynamically updating a graphical representation of data in a native graphics slide presentation system is disclosed. The method includes associating a data source with one or more abstract presentation objects embedded in a native slide of the native graphic slide presentation system. The one or more abstract presentation objects are mapped to a specific visual representation of the data in the native slide in which it is implemented. A slide representation of the native slide is presented in a slide presentation displayed as a single page web application, wherein each slide representation occupies a slide region within the single page web application.

The method may also include parsing data from the data source corresponding to the one or more abstract presentation objects for the graphic slide presentation. A change in the data source corresponding to the one or more abstract presentation objects is detected through the polling of the source data to detect if there has been a net change in the source data and if such change has occurred then the parsed data provided to the presentation objects and associated display widgets are updated and an event is fired to require the display widgets to re-render themselves again. The slide representation is automatically updated upon detecting a change to the one or more abstract presentation objects.

These and other features, aspects and advantages of the present invention will become better understood with reference to the following drawings, description and claims.

### BRIEF DESCRIPTION OF THE DRAWINGS

FIG. 1 is a flowchart illustrating the interaction of the components of the system.

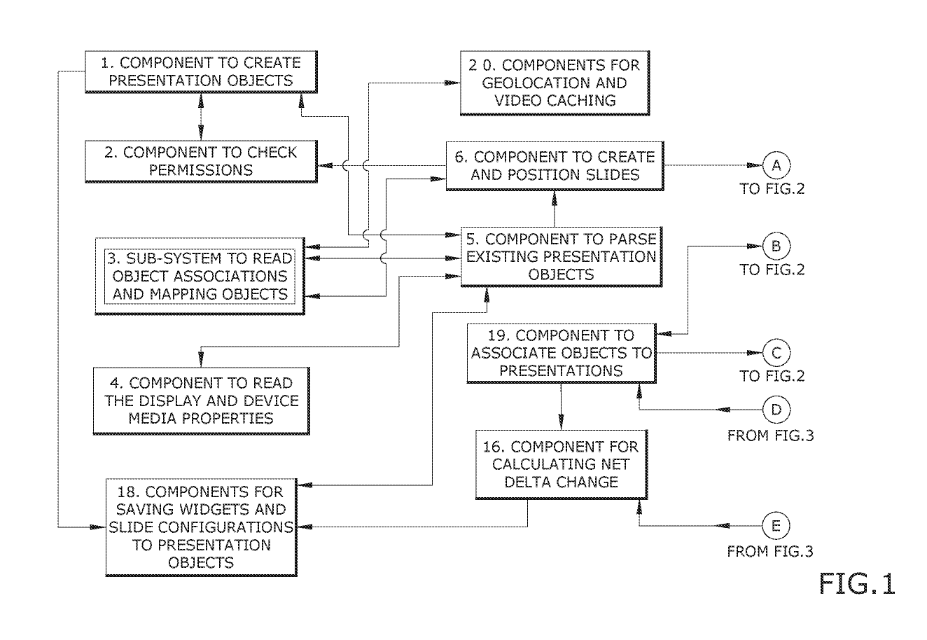

FIG. 2 is a continuation of the flowchart of FIG. 1.

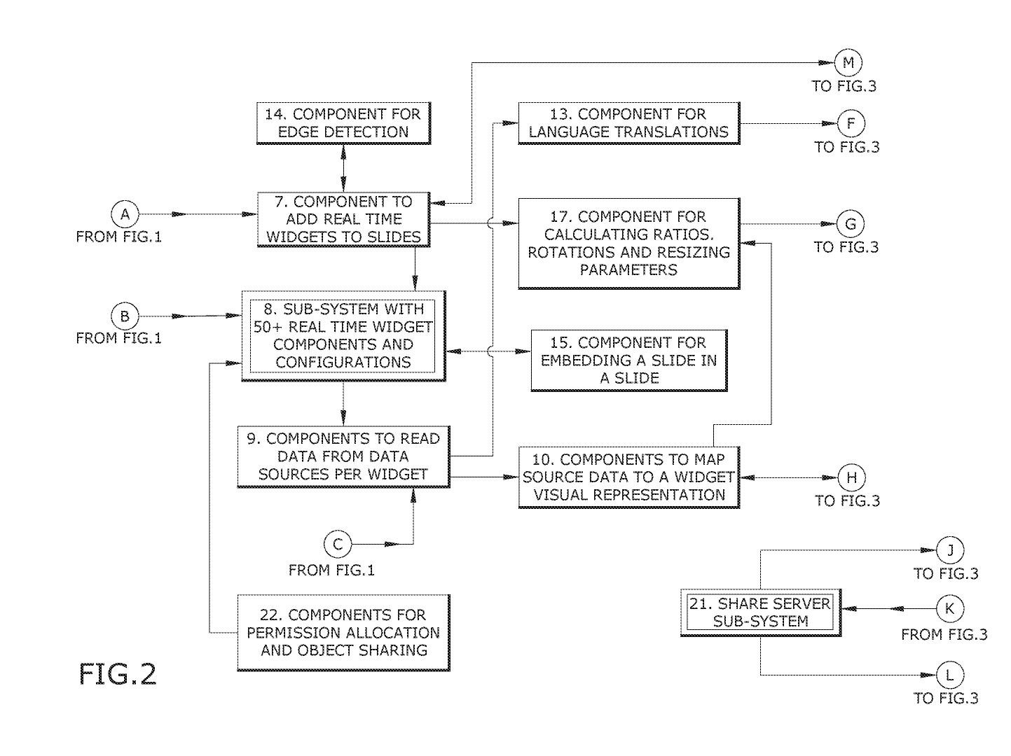

FIG. 3 is a continuation of the flowchart of FIGS. 1 and 2.

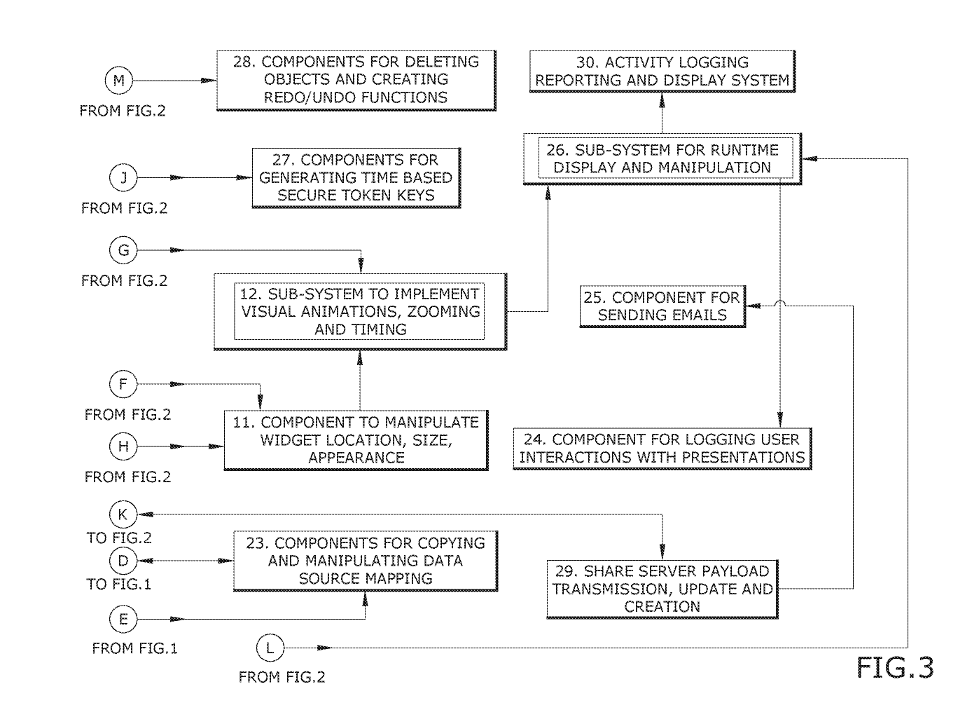

FIG. 4 is a schematic diagram of the interaction of the system with data sources via APIs and passing the data to the mapping and parsing components, object association, widget display.

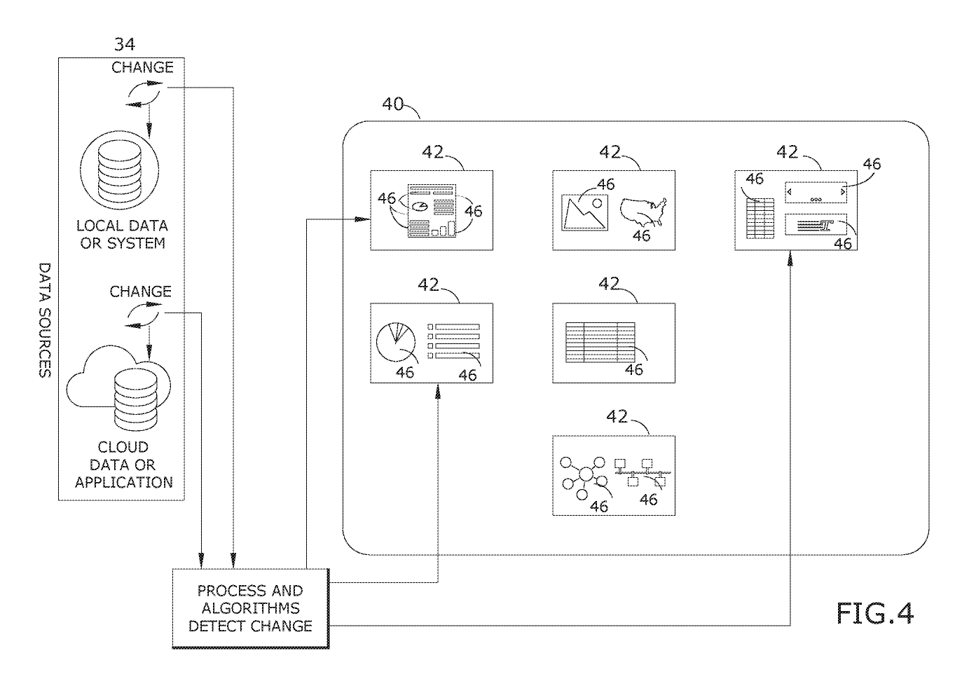

FIG. 5 is an illustration of a representative system architecture which embeds the system as a web page/component in other web systems and accesses the source data from other systems through their APIs.

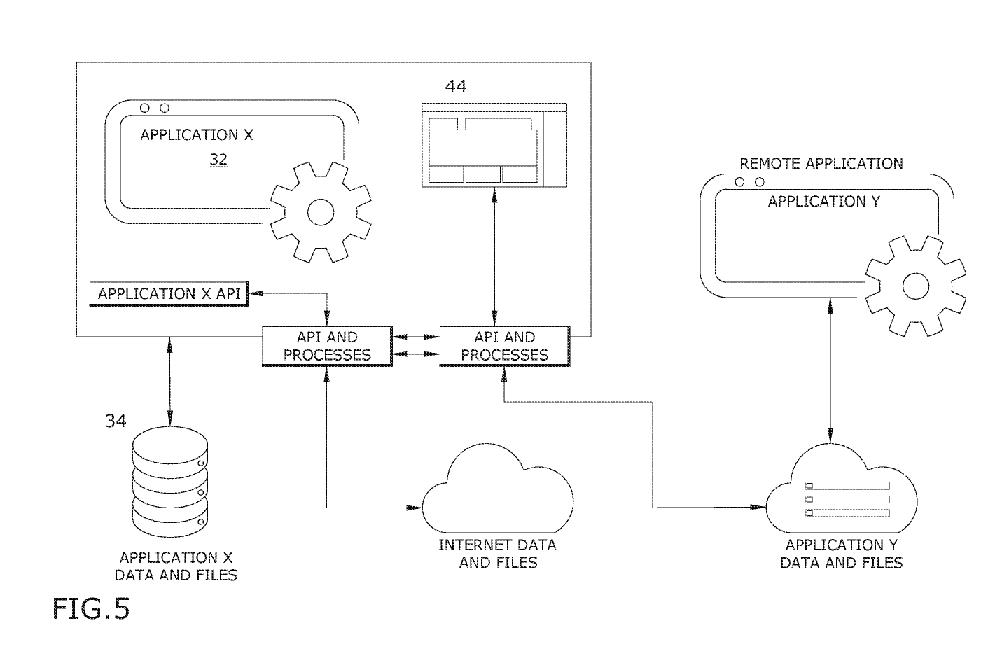

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provides a new slide presentation paradigm that is web or cloud based and utilizes software widgets (mini apps) which are dynamic, intelligently linked, and directly monitoring objects and data sources. In use, the user is guaranteed to have the most up-to-date representations, content and artifacts in the slides whenever they access the slides, without requiring any user update or reconfiguration of the slides.

Existing solutions utilize static visual representations which are a “point in time” snapshot representation and require continuous manual input, update and reconfiguration of slides. Even in rare cases where there are custom integrations to data sources, the integration will be very specific and will not allow real-time visual reconfiguration and interactivity. Existing solutions don't have facilities to dynamically link source data to visual representations that readjust themselves without user manual interaction.

The present invention solves the above by utilizing responsive user interface widgets, software functions, dynamic data updates, mapping functions, triggered events detection and configuration algorithms which monitors, interprets and translate the data into appropriate dynamic visual representations automatically in real-time when source data changes without user interaction.

The invention creates dynamic representations of data which adjust based on the display device that interacts with and monitors the data in its source location. Whenever the data changes the system recalculates and adjusts the visual representation of the data dynamically, which allows the presentation's slides to update automatically without user intervention. The invention may also use visual representations with embedded configurations, mapping, and logic that allows these representation to accept user interaction during presentation time and adjust their appearance accordingly.

The system may be divided into two modes an Edit/Slides mode and a Run/Presentation mode. Both modes utilize the same components and logic. However, in the Run mode configuration, editing and response to certain user directives and browser events are blocked and Read Only operations are enforced. Accordingly, no Create, Edit, save operations or functions, or UI component editing are available in Run mode. A presentation object creation component 1 creates abstract presentation objects in the native graphics slide presentation system. The abstract presentation objects will be part of a data model that captures the logic and rules of the presentation and the mapping of its components. The representation of the presentation object component 1 and the configuration of display widgets or presentation objects mapping and rules may be described and stored using a JSON format.

The presentation object creation component 1 may communicate bidirectionally with a check permissions component 2, and a parse presentation object component 5 to ensure uniqueness of presentation in the system and permissions. The presentation object creation component 1 may also issue a directive to a configuration save component 18 to update JSON stored strings. The purpose of the check permissions component 2 is checking operation permissions from native permissions of the current user to access data in the data and object sources, and also from specific operational application permissions of the invention stored as a hidden configuration object.

A read object associations and mapping objects subsystem 3 communicates bidirectionally with a caching component 20. The caching component 20 ensures that only changed data is reloaded into the JSON so as to improve processing time and speed. Data in the system is represented using a key/value pairs schema. The read object associations and mapping objects subsystem 3 also communicates with a create slide component 6, and a parse presentation object component 5. The read object associations and mapping objects subsystem 3 is optionally used depending on the JSON description to map and link native objects of the source data 34 to a specific visual representations in the slides 42 in which it is implemented.

A device media display properties component 4 communicates bidirectionally with a parse presentation objects component 5 and is invoked in edit, and run/display mode. The device media display properties component 4 accesses, via HTML5 media queries which retrieves the configurations of the device being used and calculates the appropriate scale and aspect ratio factors that each displayed object needs to adjust to and respond to, based on the device used compared with the original device properties associated with each display widget 46 when it was first added to a slide.

The scaling factors are determined by calculating the required ratios of aspect and zoom factors and adjusting those to maintain the fidelity of the intended display, as intended by the user during the creation phase of the slide. Since it is possible for different presentation objects on a slide to be created on different devices at different times, each presentation object stores in its properties the device and media attributes it was last modified in so as to allow for the successful adjustment and recalculation of zoom and aspect ratios of each presentation object independently during display time.

A parse presentation objects component 5 is used to parse data from JSON of an existing presentation and interacts bidirectionally with the presentation object creation component 1, the configuration save component 18, device media display properties component 4, the read object associations and mapping objects subsystem 3, and calls a slide creation component 6.

The slide create component 6 creates and calculates the position and layouts of a widget defining a slide frame 42 in a presentation and displays those in a web page 40. Each presentation is a single page web application and each slide frame 42 is a region in that page 40 that gets displayed during edit/run operations. The content within each slide frame 42 is rendered utilizing one or more display widgets 46, which may be implemented as a combination of one or more of a javascript/angular, html5, CSS3 UI elements and SVG graphs on canvas objects. The create and position slides 6 communicates with the check permissions component 2, the read object associations and mapping objects subsystem 3 and calls an add real time widgets component 7.

The add real time widgets component 7 calculates the position of a display widget 7 in a slide region, it also provides properties and configuration details to subsystem 8 in JSON format. The add real time widgets component 7 calculates the position as an offset of the slide coordinate system and not relative to the overall presentation page 40 so as to allow slides 42 to be repositioned and resized independently. The add real time widgets to slides component 7 communicates bidirectionally with an edge detection component 14, 28 and calls subsystem 8, and a sizing component 17. The edge detection component 14 calculates the boundaries of the display widget 46 in relationship to the slide 42. The edge detection component 14 prevents the display widget 46 from being placed completely outside a slide boundary 42 and become invisible on the web page 40.

A real-time widget components and configuration subsystem 8 utilizes one or more of HTML5, Angular, JavaScript and JQuery implementations of UI widgets. The Real-time widget components and configuration subsystem 8 includes a plurality of widgets 46. Each widget 46 has a wizard configuration UI which collects the configuration as stored JSON configurations strings and functions to read data, parse it, and store it in the configuration JSON for each component in the overall presentation JSON tree.

The real-time widget components and configuration subsystem 8 communicates bidirectionally with an object association component 19 which stores methods and routines of that access API functions of source data, the slide embedding component 15, calls a map source data to a widget visual representation component 9, this allows an existing slide 42n to be rendered also as a region in another slide 42 through a special display widget 46 which provides a visual nesting effect, it also utilizes the permission allocation and object sharing component 22 to ensure the current user can access the data sources represented in the embedded slide 42n.

The map source data to a widget visual representation component 9 parses the links and mapping from the object association component 19 and calls the native extract routines from the data sources 34, prepares that data as strings that are sent to an external translation service, if applicable, thru calls to a map source data to a widget visual representation component 10, and a language translations component 13.

The map source data to widget visual representation component 10 maps the input data to the UI widgets presentations from the real-time widget components and configuration subsystem 8 and also communicates bidirectionally with a widget manipulation component 11, calls the sizing component 17 to calculate the appropriate transformations and scaling of data of UI components as CSS HTML5 properties to be applied to each UI component and invoked end user interaction events are detected and passed on by the web page 40 in the browser.

The widget manipulation component 11 provides manipulation of the location, size, and an appearance of a widget 46. The component calls a visual animation and timing subsystem 12 which marshals at run time the events and CSS transformations of UI elements by passing them to the Web kit engine in the browser through Angular events, and is called by the language translations component 13.

The visual animations and timing subsystem 12 is called by the sizing component 17 and the widget manipulation component 11 and calls a Runtime subsystem 26. The language translations component 13 calls the widget manipulation component 11.

The edge detection component 14 communicates bidirectionally with the add real time widgets to slides component 7. The edge detection component 14 calculates the boundaries of the display widget 46 in relationship to the slide 42. It is used to prevent the display widget 46 from being placed completely outside a slide boundary 42 and become invisible.

A slide embedding component 15 embeds a slide 42 within a slide 42. The slide embedding component 15 communicates bidirectionally with the real-time widget components and configuration subsystem 8 and is a special component that allows a slide 42 to designate a portion of its space for a UI region that when zoomed on will display the content of another slide 42n with full interactivity, this is simply done by refocusing the viewport to the slide 42 and displaying its UI widgets 46 as though you are accessing that slide in Run mode.

A net delta calculator 16 computes the net change in any component or associated object during edit sessions to ensure fast processing and enable redo/undo operations, it communicates bidirectionally with a data source manipulation component 23 and is called by an object association component 19, and calls the configuration save component 18.

A sizing component 17 calculates ratios, rotations and resizing parameters. The sizing component 17 is called by the add real time widgets to slides component 7, the map source data to widget visual representation component 10 and calls the visual animations and timing subsystem 12.

A configuration save component 18 saves widget 46 and slide configurations to presentation objects. The configuration save component 18 is called from presentation object creation component 1, the net delta calculator component 16, and bidirectionally the parse existing presentation objects component 5.

The object association component 19 associates objects to presentations. The object association component 19 communicates bidirectionally with the real-time widget components and configuration subsystem 8 and the data source manipulation component 23. It calls the map source data to the widget visual representation component 9, net delta calculator component 16. The object association component 19 stores methods and routines that access API functions of source data 34.

A caching component 20 is configured for geolocation and video caching to ensure that data is not reloaded unnecessarily when the display widgets 46 are re-rendered on updates. The caching component 20 communicates bidirectionally with the read object associations and mapping objects subsystem 3.

In some embodiments, an optional share server subsystem 21 is provided as an additional mechanism to access dynamic, interactive presentations for external users outside of embedded presentation systems. The share server subsystem 21 is an implementation that extracts a snap shot of all the data in each widget and UI elements of each slide in the presentation and joins it with the presentation JSON along with capturing links to video URLs, files and ships that for storage into a secure web server as a presentation JSON file. The share subsystem utilizes an exact copy of the Run components from the main server with the exception that it doesn't do any data retrieval from source data without explicit direction from an authoring user of the embedded system. The external shared snapshot uses the JSON and URLs provided to it and files downloaded to it to display the presentations and slides and widgets to external (non-invention or embedded system users). The share server also checks for specific tokens that are implemented as public/private key to allow displaying the presentation in Run mode and has routines for expiring and deleting the content that was shared based on attributes that were stored in the share server with the shared presentation JSON payload.

The permission allocation and object sharing component 22 calls the real-time widget components and configuration subsystem 8 to check permission in cases of inserting slides from other presentations into the current presentation where a copy of those slides JSON is added to current presentation JSON.

A data source manipulation component 23 provides for copying and manipulating data source mappings. The data source manipulation component 23 interacts bidirectionally with object association component 19 and the net delta calculator component 16.

An interaction logging component 24 logs user interactions with a presentation. The interaction logging component 24 s is called from the Runtime subsystem 26.

An e-mail component 25 provides for sending emails. It may be implemented as a simple SMTP routine for sending notification of sharing thru email and is called from 29.

The Runtime subsystem 26 provides the rendering calls to the browser viewport changes that is called during Run mode and is called from the share server subsystem 21, the visual animations and timing subsystem 12 and calls the interaction logging component 24, and an activity logging component 30.

A security component 27 provides for generation of time based secure token keys. The security component 27 is called from the share server subsystem 21.

An object editing component 28 provides for deleting objects and creating REDO/UNDO functions. The object editing component 28 has bidirectional communication with add the real time widgets component 7 during edit mode and saves JSON configurations strings in lists and indices and utilizes push and pop like operations to inject the data in/out of the presentation JSON during edit mode.

A share server payload component 29 provides server payload transmission, update and creation. It calls the e-mail component 25 and communicates bidirectionally with the share server subsystem 21.

An activity logging component 30 logs activities associated with the presentation. The activity logging component 30 is called whenever the JSON is saved, edited or run for the presentation and the data is stored in hidden objects in the native system it is also called when certain non-UI operations like copy or share is performed successfully on presentation object.

There may be over 30,000 logic gates, over 3000 subroutines that may be created and implemented in practicing the invention. The logic gates fall into categories including a) device display and browser type and orientation analysis b) data mapping analysis c) data access analysis d) math routines and algorithms and calculations e) edge detection c) color manipulations f) image manipulation g) text truncation and representation h) date manipulations i) SVG drawing techniques j) hierarchical data constructs k) tabulation data representation l) graph rendering m) data and token encryption n) JSON parsing and sorting o) remote procedural calls p) error logging q) database access routines r) bidirectional relational to object mapping s) data caching. The logic gates are invoked based on user selection and setup of source data for the various representation in the slides during the configuration of slides and also based on the device that the presentation is being rendered to during a presentation.

A user logs into the system and creates a presentation object 44 which he/she will then add none linear ordered slides 42 in a presentation 40, the slides 42 then can contain configured intelligent widgets from the provided widget library, each widget contains visual representations that are mapped to various data sources 34 and the attributes and objects in that data source 34. The information is presented to the user in easy to understand terms that mask the complexity of the mapping or data sources. Once setup is completed the user then saves that presentation object. The invention then monitors these data sources 34 and adjusts the slides, widgets, animation and display of these presentations automatically whenever it accessed by users on any device, the users only require a compliant web browser to access and get real-time updates of these presentations and slides.

The data mapping functions and real-time update can be reconfigured and extended to accept unsolicited push of data from data sources instead of the current on-demand polling of the system. This might be useful in situations with terabytes of data sources that change very slowly or infrequently over time and does not require real-time access.

Once a presentation object 44 and its real-time data mapping have been configured, the presentation object can be shared with other users. Whenever these users access the presentation to view it, the invention will update itself and provide the users with the updated slides 42 based on the latest data from the data source 34 and also based on their access permission. The above ensures that the presentation information is always up to date and automatically configured to fit the user profile, permission, and data source changes which saves users time and effort and doesn't require the manual updates and editing that are needed in existing solutions.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for dynamically updating a graphical representation of data in a web based graphics slide presentation system, comprising:
a data source associated with one or more abstract presentation objects embedded in a slide of the graphic slide presentation;
a read object associations and mapping objects subsystem configured to map and link the one or more abstract presentation objects to a specific visual representation of the data in the slide in which it is implemented; and
a slide creation and positioning component configured to determine a position and a layout of a slide representation in a slide presentation displayed as a single page web application, wherein each slide representation occupies a slide region within the single page web application.

2. The system of claim 1, further comprising:
a parse presentation objects component configured to parse data from the data source corresponding to the one or more abstract presentation objects for the graphic slide presentation.

3. The system of claim 2, further comprising:
a device media display properties component configured to read one or more display and one or more device media properties of a computing device from which the single page web application is accessed.

4. The system of claim 3, wherein the device media display properties component 4 determines a scale and an aspect ratio in which to display the graphic slide presentation on the computing device.

5. The system of claim 4, wherein the one or more display and the one or more device media properties are read via an HTML5 media queries.

6. The system of claim 3, further comprising:
an add real time widgets component configured to determine a position of a display widget in the slide region as an offset of the slide coordinate system, to allow each slide representation to be repositioned and resized independently.

7. The system of claim 6, further comprising:
a object association component configured to associate the one or more abstract presentation objects as a link mapped to the graphic slide presentation.

8. The system of claim 7, further comprising:
a real-time widget components and configuration subsystem utilizes one or more of HTML5, Angular, JavaScript and JQuery implementations of the display widget.

9. The system of claim 8, wherein the real-time widget components and configuration subsystem includes a plurality of display widgets.

10. The system of claim 8, wherein each display widget has a wizard configuration UI which collects a widget configuration as a stored JSON configuration string and function.

11. The system of claim 8, further comprising:
a map source data to a widget visual representation component configured to parse the links and mapping from the object association component and call a native extract routine from the data source to provide input data.

12. The system of claim 11, further comprising:
a map source data to widget visual representation component maps the input data to the display widget presentation from the real-time widget components and configuration subsystem.

13. The system of claim 1, wherein the slide region is defined by a widget defining a boundary within which a slide content is visible.

14. The system of claim 13, wherein the slide content comprises:
one or more display widgets provide a visual representation of the abstract presentation object.

15. A method for dynamically updating a graphical representation of data a web based graphics slide presentation system, comprising:
associating a data source with one or more abstract presentation objects embedded in a slide of the graphic slide presentation system;
mapping the one or more abstract presentation objects to a specific visual representation of the data in the slide in which it is implemented; and
presenting a slide representation of the slide in a slide presentation displayed as a single page web application, wherein each slide representation occupies a slide region within the single page web application.

16. The method of claim 15, further comprising:
parsing data from the data source corresponding to the one or more abstract presentation objects for the graphic slide presentation.

17. The method of claim 16, further comprising:
detecting a change in the data source corresponding to the one or more abstract presentation objects; and
automatically updating the slide representation upon detecting a change to the one or more abstract presentation objects.
